(19) United States
(12) Patent Application Publication
(10) Pub. No.: US 2011/0273276 A1
(43) Pub. Date: Nov. 10, 2011

(54) COMMUNICATION DEVICE AND WIRELESS COMMUNICATION METHOD

(75) Inventors: Takashi Minemura, Ome-shi (JP); Kengo Kurose, Hamura-shi (JP); Kazutoshi Shibuya, Hino-shi (JP)

(73) Assignee: KABUSHIKI KAISHA TOSHIBA, Tokyo (JP)

(21) Appl. No.: 13/179,045

(22) Filed: Jul. 8, 2011

Related U.S. Application Data
(63) Continuation of application No. PCT/JP2010/063094, filed on Aug. 3, 2010.

(30) Foreign Application Priority Data
May 7, 2010 (JP) 2010-107635

(51) Int. Cl. H04Q 5/22

(52) U.S. Cl. 340/10.1

(57) ABSTRACT

According to one embodiment, a communication device including: a CPU; a wireless communication module; a radio signal detection module; a power supply circuit. The wireless communication module includes; a receiving module configured to receive a radio signal containing identification information from another device; a storage module configured to pre-store at least one of the identification information; a verification module configured to verify the identification information of the received radio signal against the identification information stored in the storage module; and a notification module configured to notify the CPU when the identification information of the received radio signal corresponds with the identification information stored in the storage module. The radio signal detection module makes a notification to the power supply circuit if the radio signal detection module detects the radio signal. The power supply circuit supplies the operating power to the wireless communication module if the power supply circuit receives the notification.

### CROSS-REFERENCE TO RELATED APPLICATIONS

This application is a continuation of International Application No. PCT/JP2010/063094, filed Aug. 3, 2010, which is based upon and claims the benefit of priority from Japanese Patent Application No. 2010-107635, filed May 7, 2010, the entire contents of both of which are incorporated herein by reference.

### FIELD

Embodiments described herein relate generally to a communication device having a wireless communication function, and a wireless communication method.

### BACKGROUND

At the present time, various forms of communication devices are available and also the number of users who own a plurality of communication devices is increasing. For example, such communication devices include various forms such as mobile telephones, note-type personal computers, desk-top type personal computers, game machines with wireless communication functions, music playback devices, and so on. Such communication devices differ in, for example, the sizes of the screen and keyboard, and the capacity of the CPU, and are used in a suitable scene depending on their uses.

Moreover, in the present time, there are known technologies for forming a local network among such communication devices by wireless communication such as a wireless LAN, and thereby performing synchronization processing of data among devices, or making one device function as a modem thereby connecting another device to a communication service providers' network.

Further, there is a known function called a Wake On Wireless LAN (WOW). The WOW is configured such that a wireless LAN communication module verifies whether or not a specific signal transmitted from another device is a radio signal that indicates a preregistered SSID (Service Set Identifier), and makes a notification to a host CPU when the verification succeeds.

Since the WOW can perform the verification of a radio signal received by a wireless LAN communication module without via a host CPU, it can achieve the reduction of power consumption of an entire terminal.

In a portable type communication device that is operated by power supplied from a battery, how to reduce power consumption thereby maintaining the duration of continuous operation is a critical matter. Particularly, in a communication device such as a mobile telephone that is supposed to be continuously waiting for reception of voice incoming calls and E-mails, its performance is determined by the duration of continuous operation.

In this situation, in order to perform wireless communication among a plurality of terminals, it is necessary that the wireless communication module of one terminal periodically or continuously monitors a connection establishment request from a counterpart terminal. However, periodical or continuous monitoring by a terminal requires power consumption, and therefore is a factor to degrade the duration of continuous operation of the terminal.

Moreover, even when the above described WOW is used, the wireless LAN communication module needs to be continuously activated, thus leading to a decline in the duration of waiting for voice incoming calls and so on as described above.

### BRIEF DESCRIPTION OF THE DRAWINGS

FIG. 1 is a conceptual diagram to illustrate an example of the network formed among communication devices in the first embodiment;

FIG. 2 is a configuration diagram of a hardware system of the mobile telephone as an example of the communication device in the first embodiment;

FIG. 3 is a circuit configuration diagram of a radio signal detection circuit;

FIG. 4 illustrates detailed configurations of a signal identification circuit and a control signal output circuit;

FIG. 5 is a software system configuration diagram of the mobile telephone as an example of the communication device in the first embodiment;

FIGS. 6A and 6B show examples of the UW table;

FIG. 7 is a diagram to illustrate the relation among the radio signal detection circuit, a WLAN communication module , a CPU, and a power supply circuit of the mobile telephone, and a detailed configuration of the WLAN communication module;

FIG. 8 is a hardware system configuration diagram of a PC as an example of the other communication devices in the first embodiment;

FIG. 9 is a software system configuration diagram of the PC as an example of other communication devices in the first embodiment;

FIG. 10 is a flowchart to illustrate a wireless LAN communication connection processing executed by the mobile telephone in the first embodiment;

FIG. 11 is a sequence diagram to show the wireless LAN communication connection processing performed between the mobile telephone and the PC;

FIG. 12 is a sequence diagram showing a process following FIG. 11;

FIG. 13 is a flowchart to illustrate a synchronization acquisition processing executed by the mobile telephone in the first embodiment;

FIG. 14 is a flowchart to illustrate a PC-side connection request processing executed by the PC in the first embodiment;

FIG. 15 is a flowchart to illustrate a PC-side connection request processing using a UW executed by the PC in the first embodiment;

FIG. 16 is a sequence diagram to show a wireless LAN communication connection processing using a UW, which is performed between the mobile telephone and the PC;

FIG. 17 is a sequence diagram showing a process following FIGS. 16;

FIG. 18 shows the relation among the radio signal detection circuit, a WLAN communication module , a main CPU, a sub CPU , and a power supply circuit of a mobile telephone in the second embodiment, and the detailed configuration of the WLAN communication module;

FIG. 19 is a flowchart to illustrate a wireless LAN communication connection processing executed by the mobile telephone in the second embodiment;

FIG. 20 is a sequence diagram to show a wireless LAN communication connection processing performed between the mobile telephone and the PC; and

FIG. 21 is a sequence diagram showing a process following FIG. 20.

### DETAILED DESCRIPTION

Various embodiments according to the invention will be described hereinafter with reference to the accompanying drawings.

In general, according to one embodiment of the invention, a communication device includes a CPU; a wireless communication module; a radio signal detection module; a power supply circuit. The wireless communication module includes; a receiving module that receives a radio signal containing identification information from another device; a storage module that pre-stores at least one of the identification information; a verification module that verifies the identification information of the received radio signal against the identification information stored in the storage module; and a notification module that notifies the CPU when the identification information of the received radio signal corresponds with the identification information stored in the storage module. The radio signal detection module waits for the radio signal with lower operating power than operating power when the wireless communication module waits for the radio signal. The power supply circuit supplies operating power for the wireless communication module receiving the radio signal. The radio signal detection module makes a notification to the power supply circuit if the radio signal detection module detects the radio signal. The power supply circuit supplies the operating power to the wireless communication module if the power supply circuit receives the notification.

### First Embodiment

A first embodiment of the communication device according to the present invention will be described based on the appended drawings.

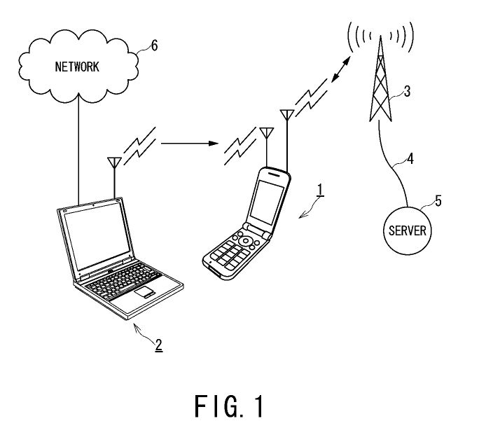

FIG. 1 is a conceptual diagram to illustrate an example of the network formed among communication devices in the first embodiment.

In the first embodiment, description will be made by applying a mobile telephone 1 and a PC 2 as the communication devices, respectively. It is possible that the mobile telephone 1 connects to a network by using the communication network of the PC 2, and it is also possible that the PC 2 connects to a network by utilizing the communication network of the mobile telephone 1, and the mobile telephone 1 and the PC 2 directly form a network. Note that description will be made in the first embodiment by applying the mobile telephone 1 and the PC 2 as the communication devices that form a network. However, various communication devices that include a communication function, such as a PDA (Personal Digital Assistant), a portable type game machine, a portable-type music player, a portable-type video player, and so on can be applied in the embodiments of the present invention.

The mobile telephone 1 transmits and receives data such as voice to and from a base station 3, which is accommodated in a mobile communication network, by using a communication scheme exemplified by a W-CDMA. The base station 3 is connected with a predetermined server 5 via a predetermined public line network 4. The mobile telephone 1 is a communication device including a function to communicate with other devices including the PC 2 by utilizing a communication system such as, for example, a wireless LAN (Local Area Network).

The PC 2 is a communication device including a function to communicate with other devices including the mobile telephone 1 by utilizing a communication system such as, for example, a wireless LAN. Moreover, the PC 2 is connected to a network 6 and performs wired and wireless transmission and reception of data.

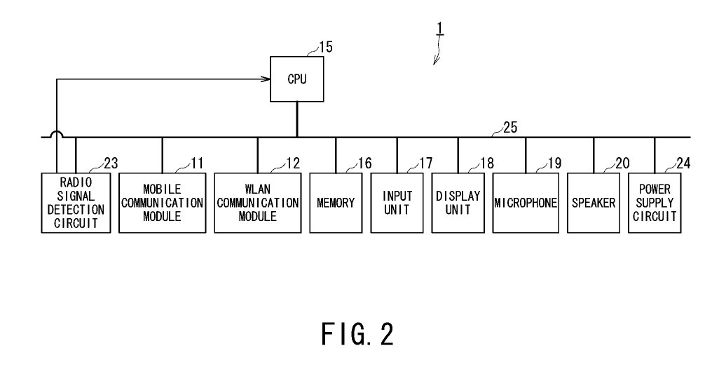

FIG. 2 is a configuration diagram of a hardware system of the mobile telephone 1 as an example of the communication device in the first embodiment.

In FIG. 2, description will be made mainly on the configuration for the mobile telephone 1 to establish wireless communication with the PC 2, and detail description on the configuration that is generally included in the mobile telephone 1 will be basically omitted.

The mobile telephone 1 includes a mobile communication module 11, a WLAN communication module 12, a CPU 15, a memory 16, an input unit 17, a display unit 18, a microphone 19, a speaker 20, a radio signal detection circuit 23, and a power supply circuit 24. Each part of the mobile telephone 1 is connected to each other by a bus 25.

The power supply circuit 24 generates a predetermined operating power supply voltage based on the output of a battery and supplies operating voltage to each circuit. The mobile telephone 1 operates based on the operating power supplied from the power supply circuit 24.

The mobile communication module 11 transmits and receives data such as voice and E-mail to and from the base station 3. The mobile communication module 11 includes an antenna not shown and receives from space a radio signal transmitted by a predetermined communication processing system from the base station 3 accommodated in a mobile communication network. Moreover, the mobile communication module 11 emits a predetermined radio signal into space via the antenna so as to communicate with the base station 3 through the predetermined communication processing system. After performing a predetermined processing on the received signal, the mobile communication module 11 outputs data to the CPU 15 and/or outputs voice from the speaker 20. Furthermore, the mobile communication module 11 performs a predetermined processing on the data outputted by the CPU 15 and the voice collected by the microphone 19, thereafter transmitting them.

The WLAN communication module 12 performs wireless LAN communication in conformity with a communication standard such as IEEE 802.11a and IEEE 802.11b via an antenna.

The CPU (Central Processing Unit) 15 generates various control signals and provides them to each unit thereby comprehensively controlling the mobile telephone 1. The CPU 15 performs various processing according to a program stored in a ROM (Read Only Memory) as the memory 16, and various application programs and control programs (firm wear) including an operating system (OS), which are loaded in a RAM (Random Access Memory) from the ROM.

The memory 16 is a storage device such as a ROM, a RAM, a flash memory element, and an HDD (Hard Disc Drive).

The input unit 17 receives an input signal via an input system, for example, of an operating key type, a touch panel type, and so on, and transfers the input signal to the CPU 15. The display unit 18 displays data made up of characters, images, and so on based on an instruction of the CPU 15. The display unit 18 is made up of, for example, an LCD (Liquid Crystal Display), an organic EL (Electro Luminescence) display, and so on.

The radio signal detection circuit 23 is a circuit for detecting an amplitude-modulated (on-off keying) radio signals sent from the PC 2 and so on. The radio signal detection circuit 23 determines the type of the radio signals based on a signal pattern of the radio signals received from the PC 2. The signal pattern is judged based on a period between successive signals (period of the power value) and a level (magnitude pattern) of each signal detected along the time axis. Hereafter, the magnitude pattern and period of the power value in the time axis (a period between successive signals and a level of each signal) of the wireless signal received by the wireless signal detection circuit 23 are referred to as a “specific pattern”. If a detected specific pattern is determined to be a pre-stored specific pattern of the radio signal to be waited for based on a result of verification, the radio signal detection circuit 23 outputs a predetermined control signal to the CPU 15 or to the power supply circuit 24 as an interrupt signal. Note that the radio signal detection circuit 23 may output a signal to the power supply circuit 24 via a bus 25, or a dedicated line prepared in advance among the three components: the radio signal detection circuit 23, the WLAN communication module 12, and the power supply circuit 24. Preparing a dedicated line for the three components makes it possible to inhibit useless activation of other devices thereby saving power consumption.

The radio signal detection circuit 23 is a circuit that can wait for a radio signal sent from the PC 2 at an operating power lower than the operating power when the WLAN communication module 12 as the wireless communication unit monitors the radio signal by itself. Note that each circuit of the radio signal detection circuit 23 can be made up by applying a conventional technology which can achieve power consumption saving, which is described in the document to be shown in every description of each circuit described later. The radio signal detection circuit 23 may have any configuration without limited to the configuration according to the below described document, provided that it can wait for a radio signal sent from the PC 2 at an operating power lower than the operating power of the WLAN communication module 12 when monitoring the radio signal.

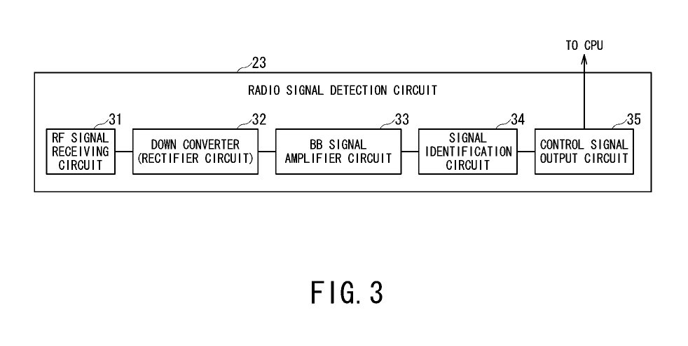

FIG. 3 is a circuit configuration diagram of the radio signal detection circuit 23 of FIG. 2.

The radio signal detection circuit 23 includes a RF signal receiving circuit 31, a down converter (rectifier circuit) 32, a baseband (BB) signal amplifier circuit 33, a signal identification circuit 34, and a control signal output circuit 35.

Upon reception of a detectable radio signal (radio wave) transmitted from a communication device such as the PC 2, the RF (Radio Frequency) signal reception circuit 31 outputs an RF signal.

The down converter (rectifier circuit) 32 rectifies and detects the RF signal outputted from the RF signal receiving circuit 31 to acquire a demodulated signal. Note that the down converter 32 is configured not to include a local oscillator for power saving. For making up the down converter 32, for example, the technology according to JP4377946B (DEMODULATING DEVICE) can be applied.

Note that the demodulating circuit according to JP4377946B is a clocked biasing rectifier circuit. Specifically, this demodulating circuit comprises: a rectifier circuit including a bias circuit that outputs a direct current voltage, a first MOS transistor in which only a direct current voltage is applied between the gate terminal and the source terminal; a second MOS transistor in which only a direct current voltage is applied between the gate terminal and the source terminal, and the drain terminal is connected to the source terminal of the first MOS transistor, a coupling capacitor in which one end is connected to the source terminal of the first MOS transistor and the other end is inputted with an alternating current signal, the rectifier circuit being configured to supply a bias voltage at a predetermined timing; and a clocked comparator configured to compare an input signal rectified by the rectifier circuit with a threshold at a timing different from the predetermined timing and to output a binary signal.

The BB signal amplifier circuit 33 amplifies a demodulated signal outputted from the down converter 32 and outputs a predetermined signal. For making up the BB signal amplifier circuit 33, for example, the technology according to JP2009-89434A (GENERATING DEVICE FOR TRIGGER SIGNAL) can be applied.

The generating device for trigger signal according to JP2009-89434A includes a current mirror circuit and a current-voltage conversion circuit. To be specific, the generating device for trigger signal comprises: a current generating unit for generating a current having an amplitude corresponding to a magnitude of a demodulated signal; a signal amplification unit including a current output unit for outputting a current which has an amplitude corresponding to the magnitude of the current generated by the current generating unit and flows from a first power supply potential to a second power supply potential, and a current mirror circuit that amplifies the current outputted by the current output unit; and a trigger signal generation unit that is connected to an output end of the current mirror circuit and converts an amplified current signal into a voltage signal to generate a trigger signal.

The signal identification circuit 34 compares a signal generated at the BB signal amplifier circuit 33 with a predetermined comparison reference potential. The signal identification circuit 34 determines that a detected signal is at a high level if the signal is a potential equal to or higher than the comparison reference potential. The signal identification circuit 34 determines that a detected signal is at a lower level if the signal is lower than the comparison reference potential. The signal identification circuit 34 acquires a level of each signal detected along the time axis and period of the voltage in the time axis, that is, a specific pattern. The signal identification circuit 34 identifies whether or not the acquired signal corresponds with the specific pattern of the radio signal to be waited for, and outputs the identification result to the control signal output circuit 35.

The control signal output circuit 35 generates a control signal to inform an occurrence of interrupt processing based on the identification result outputted from the signal identification circuit 34, and outputs the generated control signal to the CPU 15 and the power supply circuit 24.

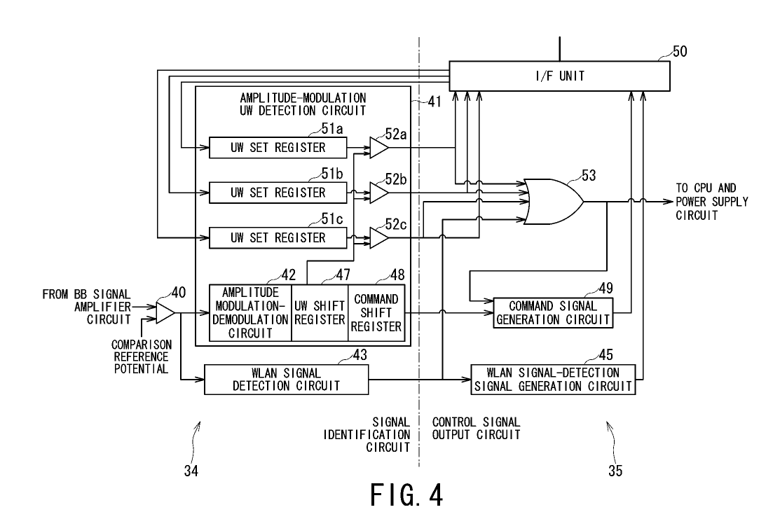

FIG. 4 illustrates detailed configurations of the signal identification circuit 34 and the control signal output circuit 35 of FIG. 3. Note that the left-hand side from the chain-line in the figure corresponds to the signal identification circuit 34 and the right-hand side corresponds to the control signal output circuit 35.

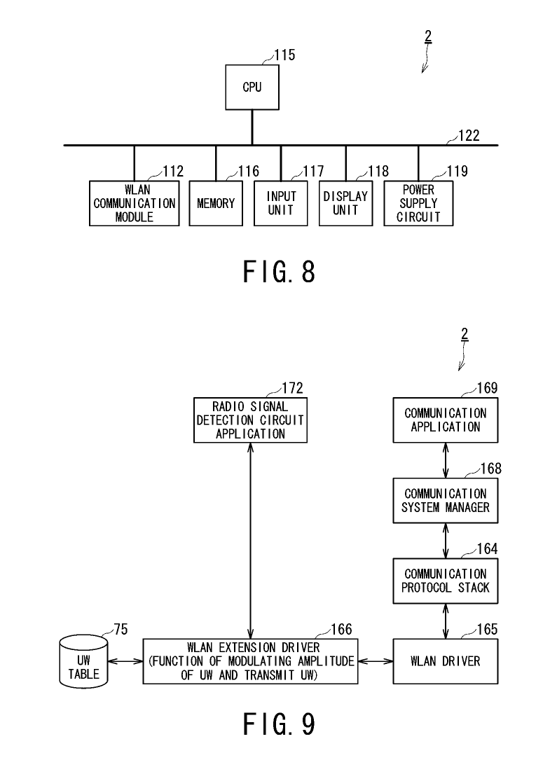

A comparator 36 of the signal identification circuit 34 compares a signal supplied from the BB signal amplifier circuit 33 with the comparison reference potential. A comparator 36 detects a signal higher than the comparison reference potential as a high level, and a signal lower than the reference potential as a low level to output each signal to an amplitude modulation-demodulation circuit 42 of an amplitude-modulation unique word (UW) detection circuit 41 and a WLAN signal detection circuit 43. The WLAN signal detection circuit 43 detects whether or not an acquired signal corresponds with a specific pattern of a radio signal such as a beacon signal or a probe request signal sent by the WLAN communication module (WLAN communication module 112 of FIG. 8) of the PC 2. Upon detection of a specific pattern that corresponds with the radio signal to be waited for, the WLAN signal detection circuit 43 notifies that to a WLAN signal-detection signal generation circuit 45 of the control signal output circuit 35.

The amplitude modulation-demodulation circuit 42 of the amplitude modulation UW detection circuit 41 performs the processing to demodulate an acquired signal. The signal that is demodulated in this step is a signal including unique word (UW) information and command information which are sent from the PC 2 described later. The amplitude modulation-demodulation circuit 42 performs demodulation processing to acquire those UW and command information. The signal outputted from the amplitude modulation-demodulation circuit 42 is supplied to a unique word (UW) shift register 47 and a command shift register 48. If a correspondence between a signal supplied to the UW shift register 47 and a UW, which is set up in any of UW set registers 51a, 51b and 51c, is detected, a command signal generation circuit 49 generates a command signal which is to be read by the CPU 15 via an interface (I/F) unit 50 in an interrupt processing.

In the unique word (UW) set registers 51a, 51b and 51c (hereafter, simply referred to collectively as a “UW set register 51”), preset UWs are stored, respectively. In the present embodiment, the UW set register 51 functions as a storage unit that pre-stores a specific pattern of at least one radio signal that is transmitted from another device. Determination is made in comparators 52a, 52b and 52c (collectively, comparator 52) on whether or not a signal supplied to the UW shift register 47 corresponds with any of the UWs set in the UW set registers 51a, 51b and 51c, respectively. Providing a plurality (three, in the first embodiment) of UW set registers 51 and corresponding comparators 52 allows the mobile telephone 1 to set UWs which are set between itself and a plurality of communication devices. This makes it possible to concurrently wait for UWs sent from different communication devices.

For a specific configuration for supplying a signal to the UW shift register 47 and performing the comparison with the UW stored in the UW set register 51, for example, the technology according to Japanese Patent Laid-Open No. 2009-33445 (RECEIVING DEVICE AND ITS METHOD) can be applied.

When a detection signal is generated by the WLAN signal-detection signal generation circuit 45, and when a correspondence between the signal supplied to the UW shift register 47 and a UW set up in any of the UW set registers 51 is detected, a notification to an OR circuit 53 is made. Upon input of any signal, the OR circuit 53 outputs a signal to the CPU 15 and the power supply circuit 24. Moreover, the WLAN signal-detection signal generation circuit 45 and each comparator 52 output a signal to be read by the CPU 15 that accepts an interrupt signal, to the I/F unit 50.

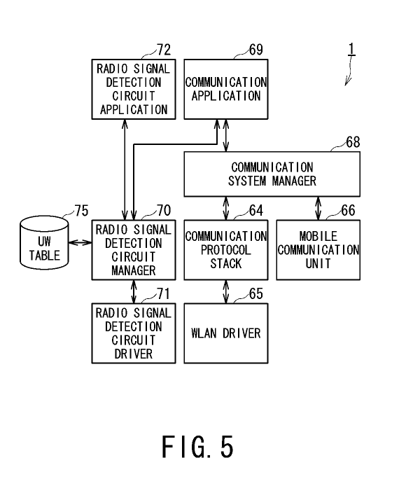

FIG. 5 is a software system configuration diagram of a mobile telephone 1 as an example of the communication device in the first embodiment. In FIG. 5, description will be made mainly on the configuration for the mobile telephone 1 to establish wireless communication with the PC 2 as one of another communication device, and detailed description on the configuration of the software generally included in the mobile telephone 1 will be basically omitted.

A communication protocol stack 64 executes a predetermined wireless LAN communication procedure. A wireless LAN (WLAN) driver 65 controls the WLAN communication module 12 to perform the procedure executed by the communication protocol stack 64. A mobile communication unit 66 controls the mobile communication module 11 during the communication utilizing communication common carrier network such as a voice call and data communication of the mobile telephone 1 to establish wireless communication.

The communication protocol stack 64 and the mobile communication unit 66 are managed by the communication system manager 68, respectively. A communication application 69 receives, for example, a communication instruction from a user and makes a notification to the communication system manager 68.

A radio signal detection circuit manager 70 comprehensively controls the radio signal detection circuit 23 and communicates with each application. A radio signal detection circuit driver 71 operates the radio signal detection circuit 23 based on the control of the radio signal detection circuit manager 70. A radio signal detection circuit application 72, for example, receives an instruction and input data from a user and notifies those to the radio signal detection circuit manager 70.

A unique word (UW) table 75 stores at least one UW set by a user and UWs specific to applications.

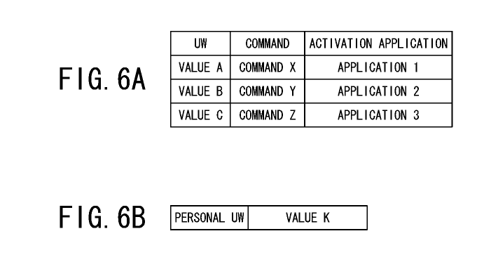

FIGS. 6A and 6B show examples of the UW table.

As shown in FIG. 6A, the UW table 75 stores: UWs that are identification information to be used when identifying the device performing a wireless communication connection processing; commands that indicate the processing to be executed by the wireless communication connection; and applications to be activated, which are assigned to combination of a UW and a command, in association with each other. Moreover, as shown in FIG. 6B, the UW table 75 also stores a personal UW which is an inter-device specific and user-free UW and which is generated by the radio signal detection circuit application 72. For UWs associated with the activation of applications, not only application specific UWs, but also a UW arbitrarily set by a user can be used. In this case, a personal UW retained in FIG. 6B is used.

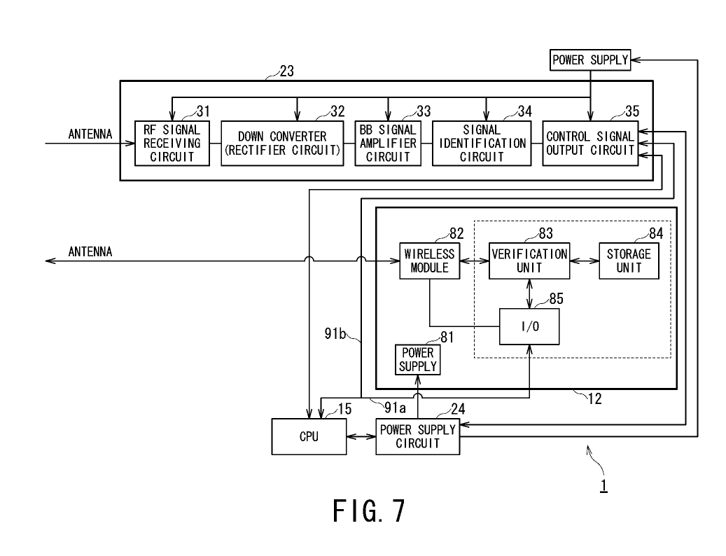

FIG. 7 is a diagram to illustrate the relation among the radio signal detection circuit 23, the WLAN communication module 12, the CPU 15, and the power supply circuit 24 of the mobile telephone 1, and a detailed configuration of the WLAN communication module 12.

The WLAN communication module 12 is operated by operating power being supplied to the power supply 81 from the power supply circuit 24. Upon receiving a radio signal from the PC 2 via an antenna not shown, the wireless module 82 outputs an SSID (Service Set Identifier), which is identification information included in a radio signal, to a verification unit 83. The verification unit 83 verifies whether or not the SSID received from the wireless module 82 corresponds with any registered SSID of another device that has been pre-stored in a storage unit 84. The storage unit 84 stores one or more SSIDs of other devices, which have been preregistered. An IN/OUT port (I/O 85) outputs a connection notification to the CPU 15 when the WLAN communication module 12 performs connection with another device based on the verification result obtained from the verification unit 83.

The WLAN communication module 12 verifies an SSID included in a radio signal received from the PC 2 against preregistered SSIDs, and performs the connection processing with the PC 2 when the SSIDs correspond with each other. That is, since the verification of SSID is performed without via the CPU 15, the mobile telephone 1 is in a low power consumption state and it is possible to perform verification of SSID and the connection processing with the PC 2 even when the CPU 15 is not operating. Note that the lower power consumption state of the mobile telephone 1 includes a sleep state, a standby state, and a hibernation state.

To the WLAN communication module 12, for example, the function of a known Wake On Wireless (WOW) LAN can be applied. The WOW is a function to access a device, which has continued to be in an idling state and has turned into a sleep state for saving power, through a wireless LAN communication connection, thereby interrupting the sleep state of the device and turning it into an activated state.

Moreover, the radio signal detection circuit 23 is connected to a signal line 91a, which connects an I/O port 85 with the CPU 15, with a signal line 91b, and monitors a connection notification to the CPU 15 made by the WLAN communication module 12.

FIG. 8 is a hardware system configuration diagram of the PC 2 as an example of the other communication devices in the first embodiment.

The PC 2 includes a WLAN communication module 112, a CPU 115, a memory 116, an input unit 117, a display unit 118, and a power supply circuit 119. Each part of the PC 2 is connected with another part by a bus 122.

The power supply circuit 119 generates a predetermined operating power supply voltage based on the output of a battery, and supplies operating power to each circuit. The PC 2 is operated based on the operating power supplied from the power supply circuit 119.

The WLAN communication module 112 performs wireless LAN communication in conformity with a communication standard such as IEEE 802.11a and IEEE 802.11b via an antenna incorporated therein.

The CPU 115 generates various control signals and provides them to each unit thereby comprehensively controlling the PC 2. The CPU 115 performs various processing according to programs stored in a ROM as the memory 116, and various application programs and control programs including an operating system (OS), which are loaded in a RAM from a ROM.

The memory 116 is a storage device such as a ROM, a RAM, a flash memory element, and an HDD.

The input unit 117 receives an input via an input system such as, for example, a key board, and a touch panel and transfers the input signal to the CPU 115. The display unit 118 displays data made up of characters, images, and so on based on an instruction of the CPU 115. The display unit 118 is made up of, for example, an LCD, and an organic EL display.

FIG. 9 is a software system configuration diagram of the PC 2 as an example of other communication devices in the first embodiment. In FIG. 9, description will be made mainly on the configuration for the PC 2 to establish wireless communication with the mobile telephone 1, and detailed description on the configuration of the software that is generally included in the PC 2 will be basically omitted.

A communication protocol stack 164 executes a predetermined wireless LAN communication procedure. A wireless LAN (WLAN) driver 165 controls the WLAN communication module 112 to perform the procedure executed by the communication protocol stack 164. A WLAN extended driver 166 is an extended driver for amplitude-modulating a UW and command stored in a UW table 175 and causing them to be transmitted by the WLAN communication module 112.

The communication protocol stack 164 is managed by the communication system manager 168.

A communication application 169, for example, receives a communication instruction from a user and makes a notification to the communication system manager 168. A radio signal detection circuit application 172 receives, for example, a UW registration instruction and input data from a user and makes a notification to the WLAN extended driver 166.

A unique word (UW) table 175 stores UWs set up by a user as with the UW table shown in FIGS. 6A and 6B. Moreover, at the time of the transmission of a UW signal, any command is sent along with the UW based on an instruction from a user received by an application and determination by the application.

Note that device authentication setting, which is needed for communication utilizing the WLAN communication modules 12 and 112, has been performed in advance between the mobile telephone 1 and the PC 2.

Next, the modes of the operation which can be taken when performing wireless LAN communication between the mobile telephone 1 and the PC 2, and the kind of the signals detected by the radio signal detection circuit 23 in each mode will be described.

In the first embodiment, the mobile telephone 1 and the PC 2 can operate in multiple modes when performing wireless LAN communication. The first operating mode is a mode of operation in which the mobile telephone 1 and the PC 2 operate as an AP master or an AP slave of an access point (hereafter, simply referred to as an “AP”) mode, respectively. The second operating mode is a mode of operation in which the mobile telephone 1 and the PC 2 operate as a master or a slave of an ad-hoc mode, respectively.

The “AP mode” is a mode in which a device that operates as an AP, as an AP master, transmits a beacon signal to another device as an AP slave. The AP mode may include not only a case in which the AP master actually functions as a relaying base station of data communication, but also a case in which the device behaves as an AP (for example, although the device transmits a beacon signal, the device does not operate as a relaying base station of data communication). An “ad-hoc mode” is mode when an ad-hoc network for communicating between devices behaving as an ad-hoc master and slave is formed.

An “AP master” denotes a device that operates as an AP and transmits a beacon signal. An “AP slave” denotes a device that operates as a device and performs passive scanning of a beacon signal transmitted from an AP, or performs active scanning thereof for an AP. An “ad-hoc master” denotes a device that operates in an ad-hoc mode and transmits a beacon signal to other devices. An “ad-hoc slave” denotes a device that performs passive scanning of a beacon signal transmitted from another device operating in an ad-hoc mode, or a device that performs active scanning of another device operating in an ad-hoc mode.

During wireless LAN communication connection in the first operating mode, the mobile telephone 1, which operates as an AP slave, can receive a beacon signal transmitted by the PC 2 operating as an AP master at the WLAN communication module 12. The mobile telephone 1 operating as an AP master can receive a signal (a probe request signal) transmitted by the PC 2 operating as an AP slave and performs active scanning at the WLAN communication module 12.

In the second operating mode, the mobile telephone 1, which operates as an ad-hoc slave, can receive a beacon signal transmitted by the PC 2, which operates as an ad-hoc master, at the WLAN communication module 12. The mobile telephone 1, which operates as an ad-hoc slave can receive a signal (a probe request signal) transmitted by the PC 2, which operates as an ad-hoc master and performs active scanning, at the WLAN communication module 12.

As described above, the WLAN communication module 12 can perform wireless LAN communication connection with the PC 2 without via the CPU 15, by verifying an SSID included in a received beacon signal and so on against a preregistered SSID, as described above. Moreover, configuration is made such that even when the mobile telephone 1 is in a low power consumption state, it can be turned into an activated state via the WLAN communication module 12.

In this case, the mobile telephone 1 in the first embodiment is configured to receive each radio signal, which is transmitted from the PC 2 to the WLAN communication module 12 in each operating mode, at the radio signal detection circuit 23 in place of the WLAN communication module 12. That is, the mobile telephone 1 can wait for a radio signal without putting the WLAN communication module 12 into a constantly activated state, by utilizing the radio signal detection circuit 23, which can wait for a radio signal transmitted from the PC 2 at a low power consumption.

Hereafter, wireless LAN communication connection processing between the mobile telephone 1 and the PC 2 in the first embodiment will be specifically described. Note that in the following description, a operating case is adopted in which the PC 2 operates as an AP master transmitting a beacon signal and the mobile telephone 1 operates as an AP slave receiving the beacon signal. If another operating case is adopted, since only the specific pattern of the radio signal detected by the radio signal detection circuit 23 and the procedure and connection form at the time of wireless LAN communication connection between the mobile telephone 1 and the PC 2 are different, description of another operating case will be omitted.

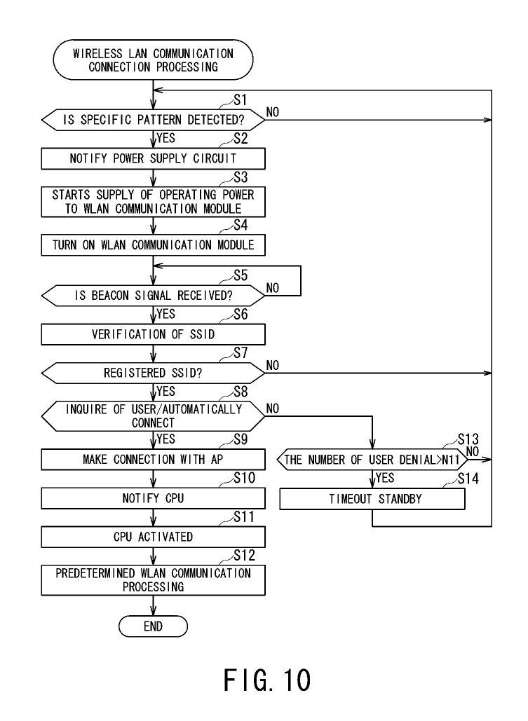

FIG. 10 is a flowchart to illustrate a wireless LAN communication connection processing executed by the mobile telephone 1 in the first embodiment.

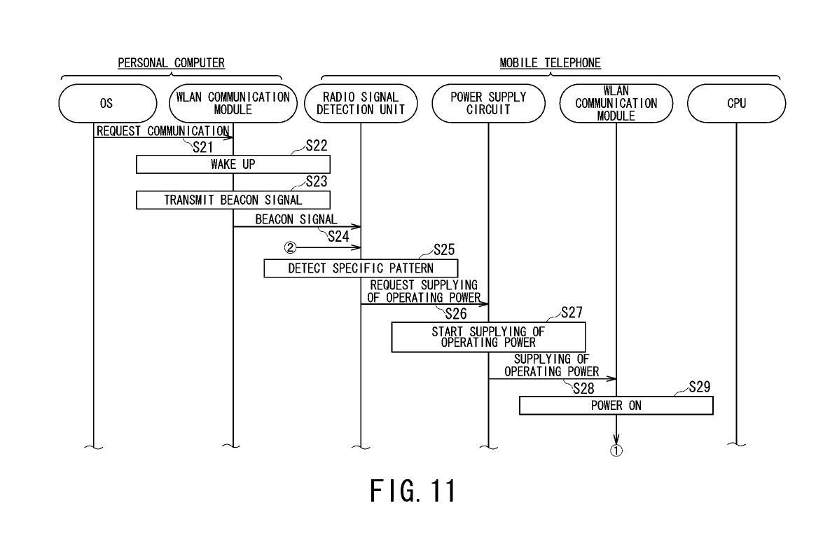

FIG. 11 is a sequence diagram to show wireless LAN communication connection processing performed between the mobile telephone 1 and the PC 2.

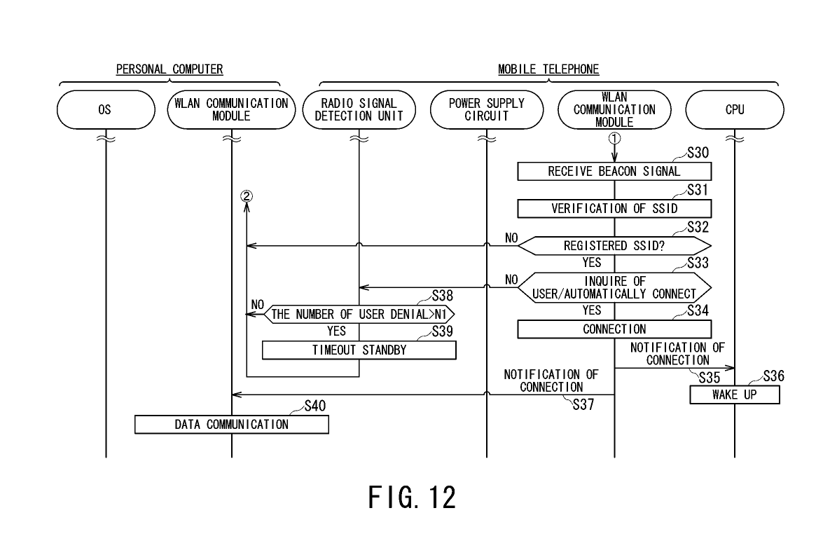

FIG. 12 is a sequence diagram showing a process following FIG. 11.

In the following description of each processing executed in the mobile telephone 1, although description will be made mostly with the radio signal detection circuit 23, the power supply 24, the WLAN communication module 12, and the CPU 15 being as the subjects, each processing is executed based on a required software program, respectively. Note that description will be made taking an example of a case in which the mobile telephone 1 is in a low power consumption state, and the CPU 15 is not operating at the start of processing.

In step S1, the radio signal detection circuit 23 of the mobile telephone 1 determines whether or not a specific pattern of the beacon signal transmitted from the PC 2 is detected. If the specific pattern is not detected, the radio signal detection circuit 23 remains to be on standby until the specific pattern of the beacon signal is detected.

On the other hand, if a specific pattern is detected (step S25 of FIG. 11), the radio signal detection circuit 23 makes a notification to the power supply circuit 24 in step S2 (step S26). That is, the radio signal detection circuit 23 requests the for WLAN communication module 12. In step S3, the power supply circuit 24 starts the supply of the operating power for the power supply 81 of the WLAN communication module 12 (step S27 and step S28). In step S4, the WLAN communication module 12 is powered ON (step S29) as operating power is supplied, and is turned into a state in which a beacon signal can be received.

In step S5, the WLAN communication module 12 determines whether or not a beacon signal transmitted by the PC 2 has been received. If the beacon signal has not been received, the WLAN communication module 12 remains on standby until the beacon signal is received. On the other hand, if the beacon signal has been received (step S30 of FIG. 12), the WLAN communication module 12 performs the verification of SSID in step S6 (step S31). Specifically, the verification unit 83 of the WLAN communication module 12 verifies the SSID included in the beacon signal received from the PC 2 against the SSID stored in the storage unit 84.

After the verification of the SSID (step S32), in step S7, the WLAN communication module 12 determines whether or not the SSID corresponds with the registered SSID . If the WLAN communication module 12 determines that the SSID included in the received beacon signal is not the registered SSID, the process returns to the detection determination step S1 (step S25 of FIG. 11) and the radio signal detection circuit 23 determines whether or not a specific pattern of the beacon signal transmitted from the PC 2 is detected.

On the other hand, if the WLAN communication module 12 determines that the SSID corresponds with the registered SSID, the WLAN communication module 12 makes a notification, in step S8, to inquire a user whether or not to connect to the AP and use wireless LAN communication (step S33 of FIG. 12). Alternatively, when a setting is made in advance in which connection to the wireless LAN is automatically performed, the WLAN communication module 12 automatically performs the connection processing. If an input from a user requesting connection with an AP has been accepted, or when setting is made to automatically connect, the WLAN communication module 12 performs connection processing with the PC 2 as an AP that has transmitted the beacon signal in step S9 (step S34), and makes a connection notification to the PC 2 (step S37). Detailed description on the procedure of wireless communication connection processing between the mobile telephone 1 and the PC 2 will be omitted since a known method (authentication and association) is used therefor.

In step S10, the WLAN communication module 12 makes a notification to the CPU 15 that connection has been made with the PC 2 (step S35). In step S11, the CPU 15 is activated (step S36), and the mobile telephone 1 comes into an operable state. In step S12, the WLAN communication module 12 appropriately performs wireless LAN communication processing with the PC 2 based on the instruction of the CPU 15.

On the other hand, in the connection determination step S8, if an input from a user not requiring a connection with an AP has been accepted, the WLAN communication module 12 makes a notification to the radio signal detection circuit 23. In step S13, the radio signal detection circuit 23 determines whether or not the number of times that an input from users not requiring a connection (denial) has been accepted is more than a predetermined number of times N1 which has been set in advance (step S38). If the number of times connection has been denied is less than N1, the process returns to the detection determination step S1 and the radio signal determination unit 23 determines whether or not a specific pattern of the beacon signal transmitted from the PC 2 has been detected.

If the number of denials is more than N1 in the number-of-time determination step S13, the radio signal detection circuit 23 sets a timer of a predetermined time and is on standby until the time is out in step S14 (step S39). If the time is out, the process returns to the detection determination step S1 again and the radio signal detection circuit 23 determines whether or not a specific pattern of the beacon signal transmitted from the PC 2 has been detected.

For example, if the number of times a user denied the connection processing is less than a predetermined number of times (N1), it is conceivable that the user request a connection at a different timing again. Therefore, the process returns to the detection determination step S1 immediately after the number-of-times determination step S13, and waits for a beacon signal. When a beacon signal has been detected again, the WLAN communication module 12 makes an inquiry to the user thereby improving the convenience of the user at the time of connection. On the other hand, when the connection processing is denied more than the predetermined number of times, the radio signal detection circuit 23 is adapted to consider that the user has no intention to make a WLAN communication connection at this timing. As a result of this, by waiting for a beacon signal after being on standby for a predetermined time period in the standby step S14, it is made possible to mitigate the inconvenience that every time a beacon signal is detected, a user is asked to make an input, and to suppress an increase in power consumption of the mobile telephone 1 for detecting useless signals.

Note that in step S7 of FIG. 10, when the SSID included in a beacon signal is not the registered SSID, the transmitted beacon signal is conceivably a beacon signal transmitted from a device other than the PC 2 to which a connection is requested.

Although the mobile telephone 1 has no intension to make a connection with a device other than the PC 2, the beacon signal will be detected at the radio signal detection circuit 23 as long as the transmission of the beacon signal is continued, and every time this happens, power will be supplied to the WLAN communication module 12.

Accordingly, if it has failed in the verification of SSID, the mobile telephone 1 is adapted to appropriately prevent useless power supply to the WLAN communication module 12.

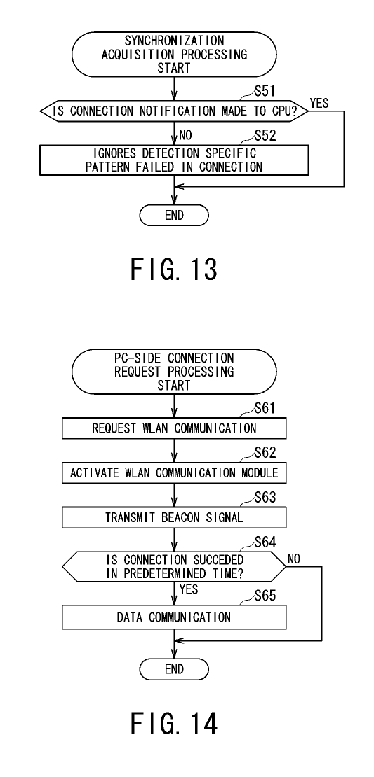

FIG. 13 is a flowchart to illustrate a synchronization acquisition processing executed by the mobile telephone 1 in the first embodiment.

The synchronization acquisition processing is a processing executed after the radio signal detection circuit 23 detects a specific pattern of beacon signal, and makes a notification to the power supply circuit 24.

In step S51, the radio signal detection circuit 23 determines whether or not a connection notification of wireless LAN communication is made from the WLAN communication module 12 to the CPU 15. If the connection notification has been made, the radio signal detection circuit 23 ends the processing.

On the other hand, for example, when a predetermined time period has elapsed without a connection notification being made, or when a notification indicating no connection has been accepted from the CPU 15 or the wireless LAN communication module 12, in step S52, the radio signal detection circuit 23 acquires the period of the specific pattern of beacon signal that has failed in connection, and when the specific pattern of beacon signal is detected again, ignores the detection and does not make a notification to the power supply circuit 24. As a result, it is possible to prevent useless power supply to the WLAN communication module 12 and useless activation of the WLAN communication module 12.

Next, a PC-side connection request processing executed in the PC 2 will be described.

FIG. 14 is a flowchart to illustrate a PC-side connection request processing executed by the PC 2 in the first embodiment.

In the following description of each processing executed in the PC 2, although description will be made mostly with the OS and the WLAN communication module 112 being as the subjects, each processing is executed based on a required software program, respectively.

In step S61, the OS of the PC 2 receives a wireless LAN communication request as an AP (step S21 of FIG. 11). In step S62, the WLAN communication module 112 is activated (wake up) based on the control by the OS (step S22). Where, the WLAN communication module 112 is activated as an AP master of the AP mode.

In step S63, the WLAN communication module 112 transmits a beacon signal for informing the mobile telephone 1 of various information including an SSID of the PC 2 (step S23 and step S24).

In step S64, the WLAN communication module 112 determines whether or not a wireless LAN communication connection with the mobile telephone 1 is succeeded in a predetermined time period. When the wireless LAN communication connection with the mobile telephone 1 is succeeded, the WLAN communication module 112 starts data communication as an AP in step S65 (step S40 of FIG. 12). On the other hand, if the wireless LAN communication connection with the mobile telephone 1 does not succeed within a predetermined time period, the WLAN communication module 112 ends the connection processing.

In the wireless LAN communication connection processing and the PC-side connection request processing, which are described in FIGS. 10 to 14, description has been made on an example in which a beacon signal is transmitted as an example of the signal transmitted from the WLAN communication module 112 of the PC 2, and the beacon signal is received by the radio signal detection circuit 23 of the mobile telephone 1. However, the above described processing may be applied to a case in which a UW, which is identification information to show the PC 2, may be transmitted in place of the beacon signal and the UW is received by the radio signal detection circuit 23. Hereafter, a PC-side connection request processing using a UW will be described.

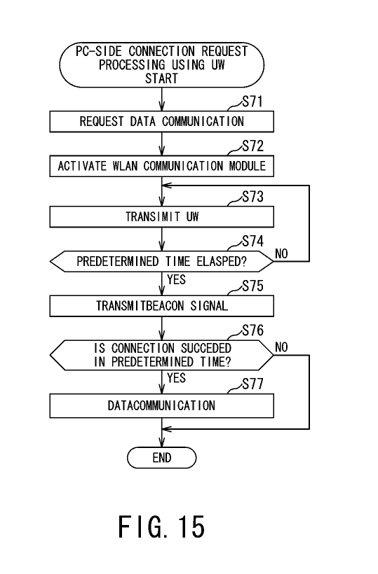

FIG. 15 is a flowchart to illustrate a PC-side connection request processing using a UW executed by the PC 2 in the first embodiment.

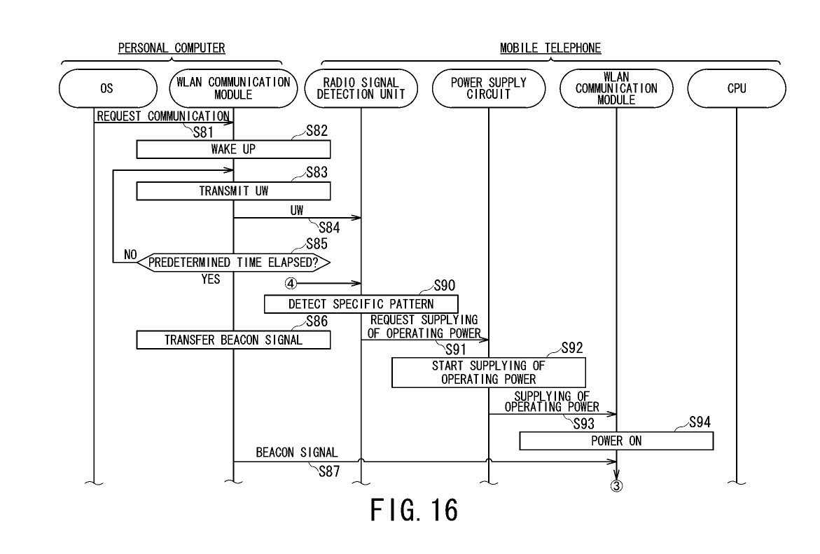

FIG. 16 is a sequence diagram to show a wireless LAN communication connection processing using a UW, which is performed between the mobile telephone 1 and the PC 2.

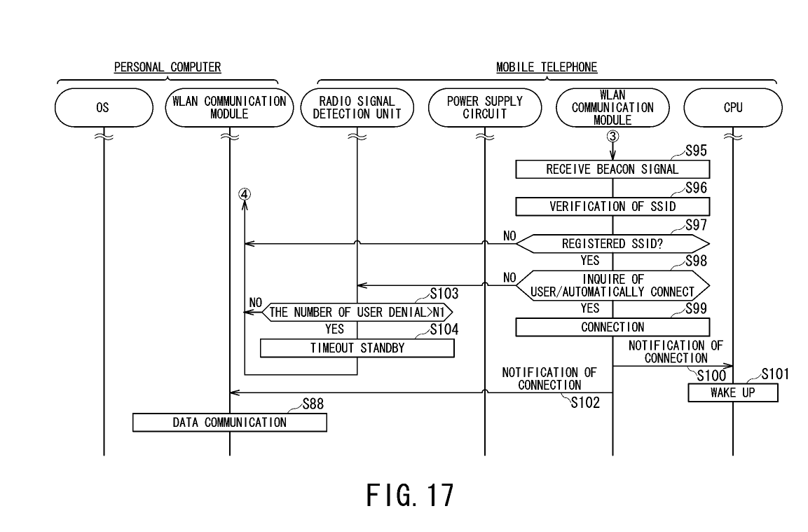

FIG. 17 is a sequence diagram showing a process following FIG. 16.

Since step S71 and step S72 (step S81 and step S82 of FIG. 16) are approximately the same as the data communication request step S61 and the WLAN communication module ON step 62 of FIG. 14 (step S21 and step S22 of FIG. 11), description thereof will be omitted here.

In step S73, the WLAN communication module 112 transmits a UW to the mobile telephone 1 (step S83 and step S84). To be specific, the WLAN communication module 112 transmits a UW which is pre-stored in the UW table 175 of the PC 2 and indicates identification information of the PC 2 (for example, a personal UW of FIG. 6B) based on the control of the WLAN extended driver 166 which has a function to amplitude-modulate and transmit the UW.

In step S74, the WLAN communication module 112 determines whether or not a predetermined time period has elapsed (step S85). If a predetermined time period has not yet elapsed, the process returns to step S73 and the WLAN communication module 112 continues the transmission of the UW.

On the other hand, if a predetermined time period has elapsed, the WLAN communication module 112 starts the transmission of a beacon signal in step S75 (step S86 and step S87).

Since step S76 and step S77 (step S88 of FIG. 17) are approximately the same as the connection determination step S64 and the data communication step 65 of FIG. 14 (step S40 of FIG. 12), description thereof will be omitted.

Note that since the wireless LAN communication connection processing using UW executed by the mobile telephone 1 is approximately the same as the above described the specific pattern detection determination step S1 (step S25 of FIG. 11) of the above described wireless LAN communication connection processing of FIG. 10 excepting that the object, of which detection or non-detection is determined, is changed from a specific pattern of beacon signal to a specific pattern of UW, description using the flowchart and description of step S90 to step S104 in FIGS. 16 and 17 will be omitted.

According to the mobile telephone 1 in the first embodiment, in place of the WLAN communication module 12, the radio signal detection circuit 23, which can be on standby at a low power consumption, can detect a radio signal such as a beacon signal and a UW so that the detection serves as a trigger for turning on the power supply of the WLAN communication module 12. As a result of this, it is possible to further reduce the power consumed by the WLAN communication module 12 even when the mobile telephone 1 in the first embodiment can verify the SSID received by the WLAN communication module 12 without via the CPU 15.

Moreover, since using a UW which is set specific to a device such as the PC 2 and is identifiable at the radio signal detection circuit 23 allows the radio signal detection circuit 23 to identify whether or not a device is connectable and thereafter to make a notification to the power supply circuit 24, it is possible to reduce useless power supply to the WLAN communication module 12.

Note that the device making a connection with the mobile telephone 1 may be an entity that keeps on periodically reporting a beacon waveform, such as an access point (AP) which is rarely operated directly by a user. Moreover, the base station 3 is not necessarily indispensable for the devices that make up the network in FIG. 1, and communication may be completed between the mobile telephone 1 and the PC 2.

### Second Embodiment

A second embodiment of the communication device relating to the present invention will be described based on the appended drawings.

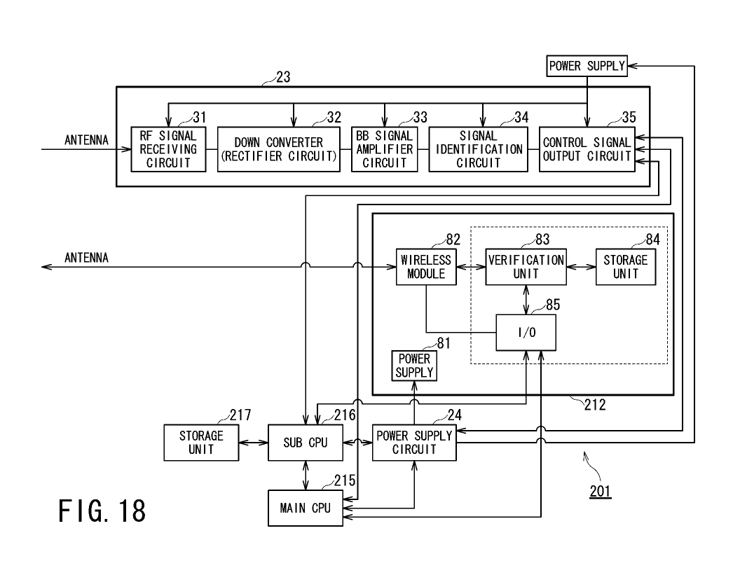

FIG. 18 shows the relation among the radio signal detection circuit 23, a WLAN communication module 212, a main CPU 215, a sub CPU 216, and a power supply circuit 24 of a mobile telephone 201 in the second embodiment, and the detailed configuration of the WLAN communication module 212. Note that since other configurations of the mobile telephone 201 and the PC 2 are approximately the same as those of the mobile telephone 1 and the PC 2 of the first embodiment, like reference numerals are given to corresponding configurations and parts, thereby omitting duplicated description.

The mobile telephone 201 as an example of the communication device in the second embodiment, differs from the mobile telephone 1 in the first embodiment in a point that it includes a sub CPU 216 including a storage unit 217.

The sub CPU 216 is a CPU operating at a lower power consumption than the main CPU 215 (that corresponds to the CPU 15 of the first embodiment). The sub CPU 216 is connected with the WLAN communication module 212, and activates the WLAN communication module 212 at a required timing.

The storage unit 217 stores a control program of the WLAN communication module 212 and required data such as SSIDs as identification information. The sub CPU 216 and the storage unit 217 are made up of, for example, a one-chip microcomputer and so on.

The WLAN communication module 212 includes a storage unit 84 that stores a control program (firmware) which is need for operation and required data such as registered SSIDs necessary for verification. The storage unit 84 is made up of a volatile memory such as a RAM and a rewritable non-volatile memory such as an EEPROM. Note that the WLAN communication module 212 may have the storage unit 84 stores at least a part of the required data such as SSIDs and the control program.

When part of the data is stored in a volatile memory, other data is stored in a non-volatile memory which is provided separately from the volatile memory. Moreover, when part of the data is stored in a volatile memory, the data stored in the storage unit 217 of the sub CPU 216 corresponds to the part of the data stored in the volatile memory.

In this situation, the WLAN communication module 212 has three operating states. The first state is an active state in which operating power is supplied from the power supply circuit 24, the WLAN communication module 212 is capable of reception of a radio signal. The second state is a sleep state. Although the WLAN communication module 212 is in a sleep state, the control program of the WLAN communication module 212 has been already downloaded, and the WLAN communication module 212 is immediately capable of reception of a radio signal when the WLAN communication module 212 switches to an active state.

A third state is a power-cut state. In the power-cut state, power is not being supplied to the WLAN communication module 212, and the WLAN communication module 212 is capable of reception of a radio signal after power is supplied and the WLAN communication module 212 downloads the control program and so on.

The mobile telephone 201 in the second embodiment acts effectively particularly when the state of the WLAN communication module 212 is in a power-cut state as the third state. Hereafter, a wireless LAN communication connection processing between the mobile telephone 201 and the PC 2 will be specifically described.

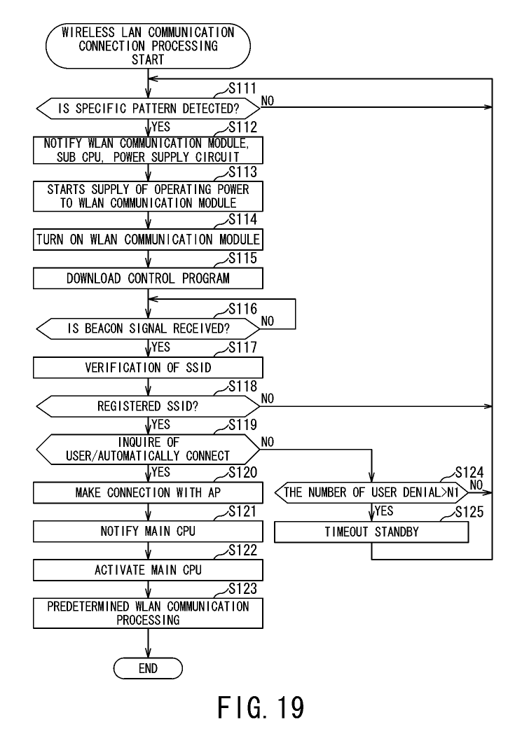

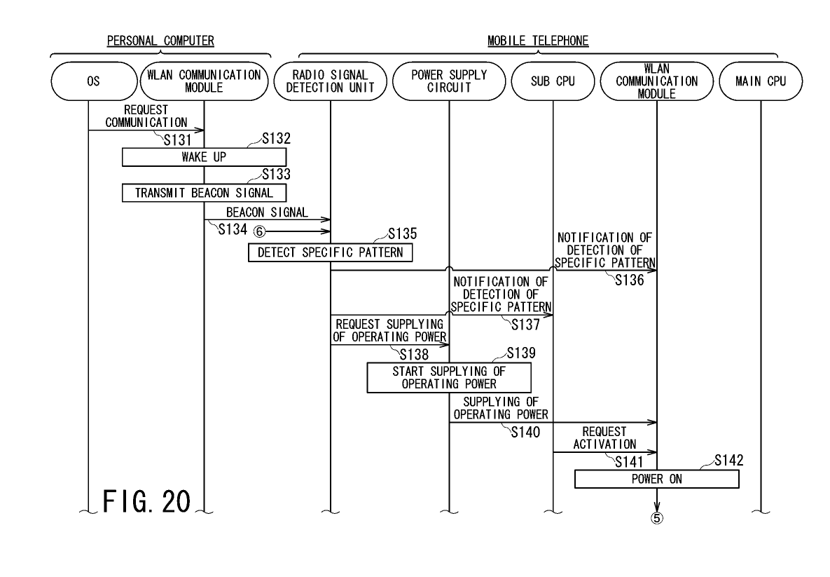

FIG. 19 is a flowchart to illustrate a wireless LAN communication connection processing executed by the mobile telephone 201 in the second embodiment.

FIG. 20 is a sequence diagram to show a wireless LAN communication connection processing performed between the mobile telephone 201 and the PC 2.

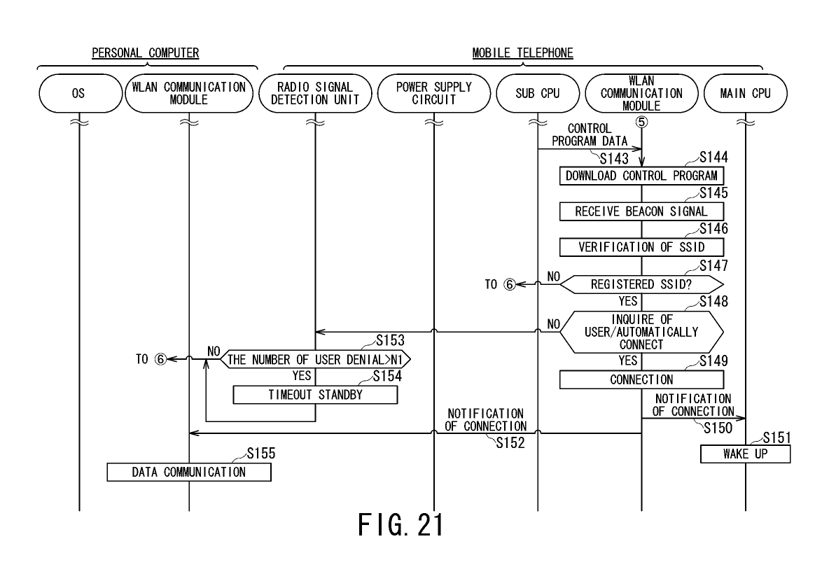

FIG. 21 is a sequence diagram showing a process following FIG. 20.

Note that description will be made on a case in which the mobile telephone 201 is in a low power consumption state, and the main CPU 215 and the sub CPU 216 are not in operation at the start of processing.

In step S111, the radio signal detection circuit 23 of the mobile telephone 201 determines whether or not a specific pattern of beacon signal transmitted from the PC 2 has been detected. When the specific pattern of beacon signal has not been detected, the radio signal detection circuit 23 is on standby until it is detected.

On the other hand, when a specific pattern is detected (step S135 of FIG. 20), in step S112, the radio signal detection circuit 23 makes a notification to the WLAN communication module 212, the sub CPU 216, and the power supply circuit 24 (step S136 to step S138). In step S113, the WLAN communication module 212 starts being supplied with operating power by the power supply circuit 24 and is activated by the sub CPU 216 (step S139 to step S141).

Since step S114 (step S142) is approximately the same as the WLAN communication module ON step S4 of FIG. 10 (step S29 of FIG. 11), description thereof will be omitted here.

In step S115, the WLAN communication module 212 downloads the control program, etc. stored in the storage unit 217 of the sub CPU 216 via the sub CPU 216 (step S143 and step S144 of FIG. 21). As a result of this, the WLAN communication module 212 becomes operable and able to receive radio signals thereafter.

Since the processing of steps S116 to S125 (step S145 to step S154) are approximately the same as those from the beacon reception determination step S5 to the standby step S14 of FIG. 10 (step S30 to step S39 of FIG. 12), the description thereof will be omitted here. Note that in the notification step S121 (step S150 of FIG. 21), the WLAN communication module 212 notifies the CPU 215 after the completion of connection. However, the WLAN communication module 212 may notify the sub CPU 216 after the completion of connection. For example, the processing is performed at the sub CPU 216 if the processing is simple, and the processing is performed at the main CPU 215 if the amount of data to be handled is large, or if notification to a user and input operation are assumed.

Note that since the PC-side connection request processing executed by the PC 2 in the second embodiment is approximately the same as the PC-side connection request processing of FIG. 14 described above, description using a flowchart, and description of steps S131 to S134 of FIG. 20 and steps S155 of FIG. 21 will be omitted.

According to the mobile telephone 201 in the second embodiment, even when the function of the above described WOW is not provided, it is possible to reduce power consumption of the entire mobile telephone 201. That is, it is possible to achieve a similar function to the WOW at a low power consumption, by putting the WLAN communication module 212 into a power-cut state during normal time, and performing the downloading of activation and control programs and so on via the sub CPU 216 which operates at a low power consumption, as needed.

Moreover, even for a case in which though the function of WOW is provided, the power consumption (for example, power consumption during a sleep mode) of the WLAN communication module 212, which is necessary for utilizing the WOW function, is large and thereby is not advantageous for the reduction of power consumption, it is possible to inhibit the increase in power consumption by applying the mobile telephone 201 in the second embodiment.

Although several embodiments of the present invention have been described above, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A communication device, comprising:
a CPU;
a wireless communication module comprising:
a receiving module configured to receive a radio signal containing first identification information from another device;
a storage module configured to pre-store second identification information;
a verification module configured to verify the first identification information of the received radio signal against the second identification information stored in the storage module; and
a notification module configured to notify the CPU when the first identification information of the received radio signal corresponds with the second identification information stored in the storage module;
a radio signal detection module configured to detect the radio signal, the radio signal detection module having a lower operating power than the wireless communication module; and
a power supply circuit configured to supply operating power for the wireless communication module receiving the radio signal,
wherein the radio signal detection module is configured to notify the power supply circuit when the radio signal detection module detects the radio signal, and
wherein the power supply circuit is configured to supply the operating power to the wireless communication module when the power supply circuit is notified.

2. The communication device according to claim 1, wherein the radio signal detection unit comprises:
an RF signal circuit configured to receive the radio signal and to output an RF signal;
a rectifier configured to rectify and detect the RF signal, and to acquire a demodulation signal;
a baseband signal amplifier configured to amplify the demodulated signal and to output an amplified signal;
a signal identification circuit configured to identify whether or not the radio signal is detected by comparing a pattern of the amplified signal with a pattern of the radio signal, the pattern being based on a period between successive signals and a level of each signal detected over time; and
a control signal output configured to notify the power supply circuit based on an identification result output from the signal identification circuit.

3. The communication device according to claim 2, wherein the radio signal detection module further comprises a storage module configured to pre-store the pattern of the radio signal transmitted from the another device, and to detected the radio signal by verifying the pattern of the received radio signal against the pattern stored in the storage module.

4. The communication device according to claim 1, wherein the radio signal detection module is configured to stop notifying the power supply if the radio signal detection module notifies the power supply and the notification module does not notify the CPU.

5. The communication device according to claim 1, wherein the wireless communication module comprises a wireless LAN communication module.

6. The communication device according to claim 1, wherein the radio signal comprises identification information used to identify the another device, the radio signal comprising a unique word information that is set by the another device.

7. A communication device, comprising:
a main CPU;
a wireless communication module comprising:
a receiving module configured to receive a radio signal containing first identification information from another device;
a volatile storage module configured to store at least a part of at least one of the identification information and a control program for operation;
a verification module configured to verify the identification information of the received radio signal against the identification information stored in the storage module; and
a notification module configured to notify the main CPU when the identification information of the received radio signal corresponds with the identification information stored in the storage module;
a radio signal detection module configured to detect the radio signal, the radio signal detection module having a lower operating power than the wireless communication module;
a power supply circuit configured to supply operating power for the wireless communication module receiving the radio signal; and
a sub CPU configured to have a lower power consumption than power consumption of the main CPU, the sub CPU comprising a sub CPU storage module configured store at least a part of at least one of the identification information and the control program,
wherein:
the radio signal detection module is configured to notify the power supply circuit and the sub CPU when the radio signal detection module detects the radio signal,
the power supply circuit is configured to supply the operating power to the wireless communication module when the power supply circuit is notified,
the sub CPU is configured to activate the wireless communication module when the sub CPU is notified, and
the wireless communication module is configured to download at least a part of at least one of the identification information and the control program stored in the sub CPU storage module after the wireless communication module is activated, and starts receiving the radio signal.

8. A wireless communication method comprising:
preparing a CPU, a wireless communication module configured to transmit and receive a radio signal containing identification information to and from another device, and a radio signal detection module configured to detect the radio signal, the radio signal detection module having a lower operating power than the wireless communication module;
detecting the radio signal at the radio signal detection module;
supplying operating power for the wireless communication module receiving the radio signal to the wireless communication module when the radio signal detection module detects the radio signal;
receiving the radio signal from the another device by the wireless communication module;
verifying, by the wireless communication module, the identification information of the received radio signal against a pre-stored identification information; and
notifying the CPU when the identification information of the received radio signal corresponds with the pre-stored identification information.
